(19) United States
(12) Patent Application Publication
(10) Pub. No.: US 2026/0077599 A1
(43) Pub. Date: Mar. 19, 2026

(54) DRAWING MACHINE

(71) Applicant: KEYENCE CORPORATION, Osaka (JP)

(72) Inventors: Hajime Hashimoto, Osaka-shi (JP); Ryohei Suzaki, Osaka-shi (JP)

(73) Assignee: KEYENCE CORPORATION, Osaka (JP)

(21) Appl. No.: 19/325,879

(22) Filed: Sep. 11, 2025

(30) Foreign Application Priority Data
Sep. 18, 2024 (JP) 2024-160594

(51) Int. Cl. B41J 2/18; B41J 2/175; B41J 2/20; B41J 3/28; B41J 29/46

(52) U.S. Cl. CPC B41J 2/18; B41J 2/175; B41J 2/20; B41J 3/286; B41J 29/46

(57) ABSTRACT

The pressure fluctuation of ink can be suppressed even with a simple structure. A print head of a drawing machine includes a first port that receives supply of ink from an ink tank, a second port that discharges ink, a pressure fluctuation adjustment section, and a third port that receives air supply to the pressure fluctuation adjustment section. The drawing machine includes an electromagnetic valve that opens and closes an air flow path for supplying air to the pressure fluctuation adjustment section via the third port. When the print head does not eject ink, the electromagnetic valve is opened to enable air to be supplied into the pressure fluctuation adjustment section.

### CROSS-REFERENCE TO RELATED APPLICATIONS

The present application claims foreign priority based on Japanese Patent Application No. 2024-160594, filed Sep. 18, 2024, the contents of which are incorporated herein by reference.

### BACKGROUND OF THE INVENTION

### 1. Technical Field

The present disclosure relates to a drawing machine that ejects ink for drawing information on an object to be drawn.

### 2. Description of the Related Art

For example, a drop on demand (DOD) type inkjet print apparatus that performs printing by ejecting ink onto a packaging material such as cardboard is known (See, for example, JP2020-131141A). The inkjet print apparatus disclosed in JP2020-131141A is equipped with a print head in which a large number of nozzles are arranged in a direction orthogonal to a conveying direction of an object to be drawn.

Furthermore, JP4543952B2 discloses a print head including a reservoir unit that temporarily stores ink to be supplied to a nozzle.

In the reservoir unit of JP4543952B2, a part in which ink is accommodated and a space opened to the atmosphere are provided, and a damper sheet for suppressing pressure fluctuation of the ink is provided between the ink and the atmosphere.

However, in the case of the reservoir unit disclosed in JP4543952B2, since the damper sheet needs to be provided inside, the structure of the reservoir unit becomes complicated.

### SUMMARY OF THE INVENTION

The present disclosure has been made in view of such a point, and an object of the present disclosure is to make it possible to suppress pressure fluctuation of ink even with a simple structure.

In order to achieve the above object, a drawing machine according to one embodiment of the present disclosure can be assumed to be a drawing machine that ejects ink for drawing information on an object to be drawn conveyed by a conveyor. The drawing machine includes: an ink tank configured to accommodate ink; a collection tank configured to collect ink; a print head including a first port that receives supply of ink from the ink tank, a second port that discharges ink to the collection tank, a pressure fluctuation adjustment section disposed in a middle of an ink flow path between the first port and the second port, and a third port that receives air supply to the pressure fluctuation adjustment section, and configured to eject ink from the first port toward the object to be drawn that is being conveyed; a first electromagnetic valve disposed in a middle of an air flow path that supplies air to the pressure fluctuation adjustment section via the third port, and configured to open and close the air flow path; and an air supply control section configured to open the first electromagnetic valve and supply air into the pressure fluctuation adjustment section when the print head does not eject ink.

According to this configuration, the ink received from the first port and the air received from the third port are brought into contact with each other in the pressure fluctuation adjustment section, whereby the pressure fluctuation adjustment section functions as a damper. By opening the air flow path by the first electromagnetic valve when the ink is not ejected by the print head, an amount of air inside the pressure fluctuation adjustment section can be maintained within an appropriate range, so that the pressure fluctuation adjustment section can suppress the pressure fluctuation of the ink while having a simple structure without providing a damper sheet inside the pressure fluctuation adjustment section.

As described above, the pressure fluctuation of the ink can be suppressed even with a simple structure.

### BRIEF DESCRIPTION OF THE DRAWINGS

FIG. 1 is a diagram illustrating an overall configuration of an inkjet print apparatus according to an embodiment of the present invention;

FIG. 2 is a block diagram of an inkjet print apparatus;

FIG. 3 is a plan view illustrating an installation example of a drawing machine and an inspection machine;

FIG. 4 is a front view illustrating an installation example of the drawing machine and the inspection machine;

FIG. 5 is a perspective view of the drawing machine as viewed from the front;

FIG. 6 is a perspective view of the drawing machine with an upper cover detached as viewed from above;

FIG. 7 is a perspective view illustrating a state in which a casing accommodating an absorber is detached;

FIG. 8 is a perspective view illustrating a state in which an ink reception portion is detached;

FIG. 9 is a view illustrating a positional relationship of a print head, an ink reception portion, and an ink tank as viewed from above;

FIG. 10 is a cross-sectional view of the ink reception portion;

FIG. 11 is a view of the drawing machine body as viewed from the front from which the print head is detached;

FIG. 12 is a perspective view of the print head as viewed from the front;

FIG. 13 is a perspective view of the print head as viewed from the rear;

FIG. 14 is a schematic diagram illustrating a flow path structure of the drawing machine;

FIG. 15 is a schematic diagram illustrating a detailed structure of the print head;

FIG. 16 is a diagram corresponding to FIG. 15 illustrating a flow of ink during drawing;

FIG. 17 is a diagram illustrating flows of air and ink at the time of self weight refreshing;

FIG. 18 is a flowchart illustrating an example of a procedure of self weight refreshing;

FIG. 19 is a diagram illustrating flows of air and ink at the time of pump refreshing; and

FIG. 20 is a flowchart illustrating an example of a procedure of pump refreshing.

### DETAILED DESCRIPTION

Hereinafter, embodiments of the present invention will be described in detail with reference to the drawings. Note that the following description of preferred embodiments is merely exemplary in nature and is not intended to limit the present invention, its application, or its use.

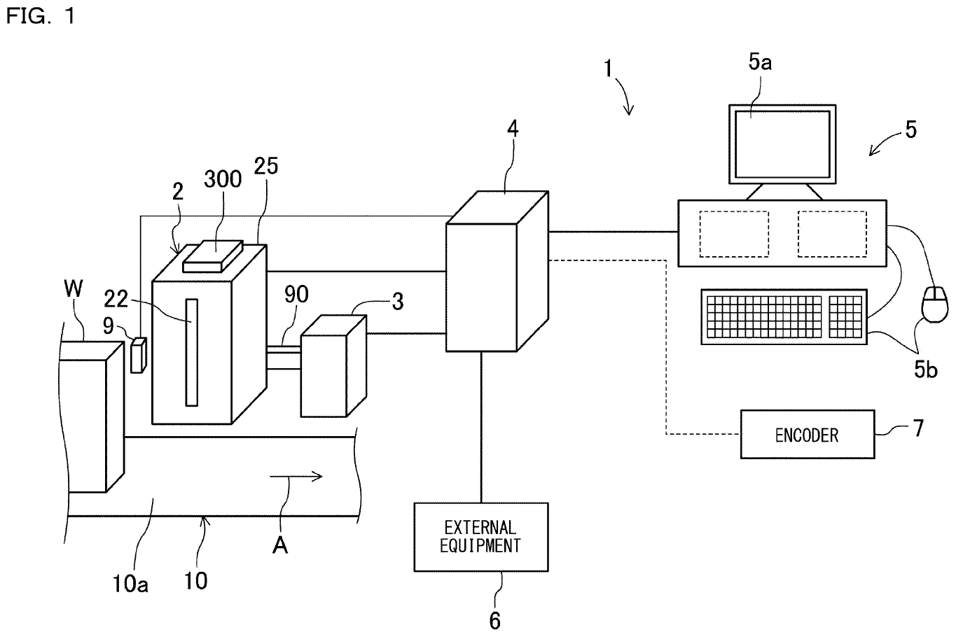

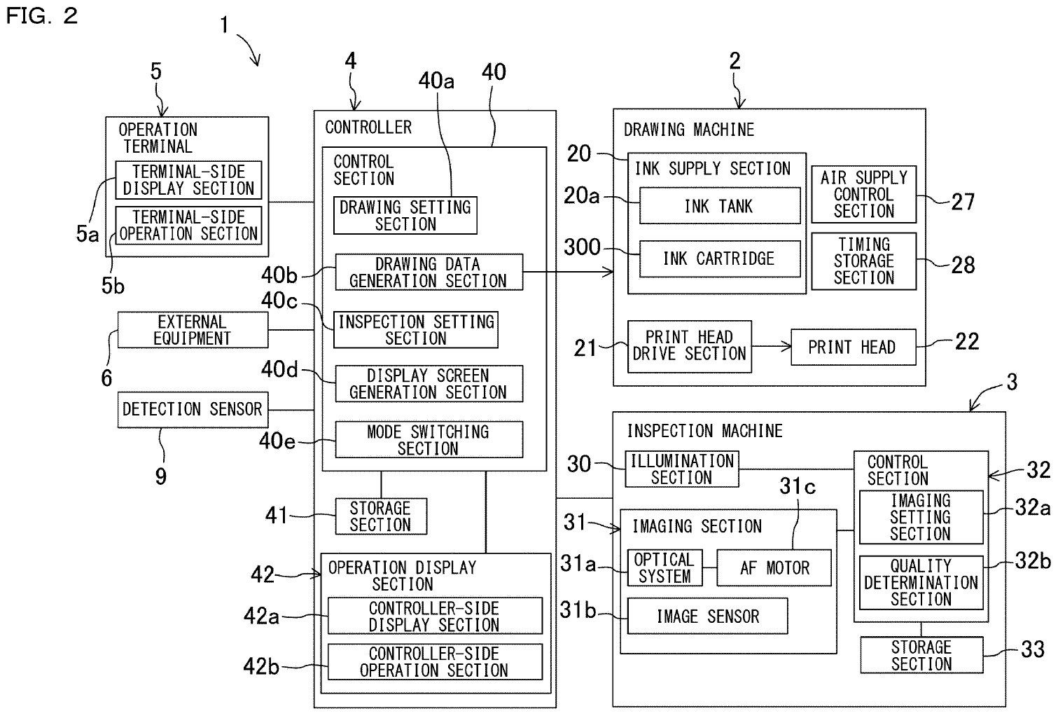

FIG. 1 is a diagram schematically illustrating an overall configuration at the time of operation of an inkjet print apparatus 1 including a drawing machine 2 according to an embodiment of the present invention, and FIG. 2 is a block diagram of the inkjet print apparatus 1. The inkjet print apparatus 1 includes, for example, a drawing machine 2, an inspection machine 3, a controller 4, and an operation terminal 5.

The drawing machine 2 is a part that performs drawing processing on an object to be drawn, and is configured separately from the controller 4. The inspection machine 3 is a part that determines the quality of the drawing state executed on the object to be drawn by the drawing machine 2, and is configured separately from the controller 4. Since the inkjet print apparatus 1 according to the present embodiment includes the drawing machine 2 and the inspection machine 3, the inkjet print apparatus 1 is an inkjet print apparatus that ejects ink for drawing information onto an object and determines the quality of a drawing state by imaging.

The controller 4 is a part that controls the drawing machine 2 and the inspection machine 3, and can also be referred to as a control device, a control unit, or the like. Furthermore, the operation terminal 5 includes a personal computer or the like, and is a part where a user inputs drawing information, performs various settings, selects, confirms, and the like, for example. The operation terminal 5 includes a terminal-side display section 5a including, for example, a liquid crystal display, and a terminal-side operation section 5b including a keyboard, a mouse, a pointing device, and the like.

The above configuration example is an example, and the present invention is not limited to the above configuration example. That is, the controller 4 may be incorporated into the operation terminal 5 or may be incorporated into the drawing machine 2. Furthermore, the operation terminal 5 may function as the controller 4. Furthermore, FIGS. 1 and 2 illustrate external equipment 6 including a programmable logic controller (PLC) or the like, and the external equipment 6 is communicably connected to the controller 4. A control signal output from the external equipment 6 is input to the controller 4. The external equipment 6 may be equipment constituting a part of the inkjet print apparatus 1, or may be equipment different from the inkjet print apparatus 1.

The inkjet print apparatus 1 is an apparatus for forming a drawing pattern on a workpiece W (an example of a drawing object) conveyed in a horizontal direction by a conveyor (an example of a conveyance device) 10, and is an in-line apparatus used by being incorporated in a manufacturing line (also referred to as a production line). The conveyor 10 is, for example, a belt conveyor, a roller conveyor, or the like. The production line is configured by the conveyor 10. The production line is installed in various factories, warehouses, and the like. The drawing machine 2 is fixed such that the relative position with respect to the conveyor 10 has a predetermined positional relationship.

During operation of the inkjet print apparatus 1, the plurality of workpieces W are sequentially conveyed in the direction of the arrow A illustrated in FIG. 1 in a state of being placed on a conveyance surface 10a of the conveyor 10. Therefore, the upstream side in the conveying direction is the left side in FIG. 1, and the downstream side in the conveying direction is the right side in FIG. 1. The plurality of workpieces W are placed on the conveyance surface 10a in a state of being spaced apart from each other in the direction of the arrow A which is the conveying direction. A direction orthogonal to the direction of the arrow A and along the conveyance surface 10a is defined as a width direction.

The workpiece W is not particularly limited, and examples thereof include a packing material for packing various products. As a typical example of the packing material, for example, cardboard and the like can be mentioned. The inkjet print apparatus 1 draws information such as characters including numbers, symbols, bar codes, two-dimensional codes, images, marks, illustrations, combinations thereof, and the like on the workpiece W conveyed by the conveyor 10. In a case where only characters are drawn, the inkjet print apparatus 1 can also be referred to as a printing apparatus or the like, and the drawing machine 2 can also be referred to as a printing machine. Furthermore, the drawing of information by the inkjet print apparatus 1 also includes the case of printing an image or the like. In this case, the inkjet print apparatus 1 can be referred to as a print apparatus. In the following description, printing and printing are simply referred to as drawing.

Furthermore, an encoder 7 for detecting a position of the workpiece W, a detection sensor 9 to be described later, and the like are connected to the controller 4. The controller 4 detects the position of the workpiece W on the basis of signals output from the encoder 7 and the detection sensor 9. The controller 4 controls the drawing machine 2 so that drawing is started when the workpiece W arrives at a predetermined position.

### (Configuration of Drawing Machine 2)

The drawing machine 2 is a drop on demand (DOD) type drawing machine that ejects ink only when necessary as a drawing operation, but may be a continuous ink jet (CIJ) type drawing machine that ejects ink even when the drawing operation is not performed, in addition to the DOD type drawing machine. Hereinafter, a case where a DOD type drawing machine is used as the drawing machine 2 of the present embodiment will be described.

As illustrated in FIG. 2, the drawing machine 2 includes an ink supply section 20, a print head drive section 21, and a DOD print head (Hereinafter, referred to as a print head.) 22. The drawing machine 2 also includes a drawing machine body 25 (illustrated in FIG. 1) provided with a print head 22. The drawing machine body 25 is fixed to the conveyor 10 or the like.

The print head 22 is accommodated and fixed inside the drawing machine body 25, and the positional relationship between the drawing machine body 25 and the print head 22 is fixed. Furthermore, the ink supply section 20 and the print head drive section 21 are also accommodated inside the drawing machine body 25.

The print head 22 of the DOD type drawing machine 2 is, for example, a member corresponding to an ejection section, and ejects ink supplied from the detachable cartridge 300 toward the workpiece W conveyed by the conveyor 10. The nozzle groups 22a provided on the front end surface of the print head 22 are arranged in the direction of gravity, that is, the up-down direction. A drawing pattern is formed on the workpiece W by the ink ejected from the nozzle group 22a of the print head 22. There are a plurality of types of structures of the print head 22, and for example, any of a thermal inkjet type, a valve jet type, and a piezo type may be used. In the present embodiment, a piezoelectric print head capable of performing low resolution to high resolution drawing, having a wide drawing width, and having high durability is used as the print head 22. The ink ejected from the print head 22 jumps from the drawing machine body 25 to the outside of the drawing machine body 25 and adheres to the workpiece W.

The ink supply section 20 is a portion that supplies ink to the print head 22, and includes an ink tank 20a that accommodates ink to be supplied to the print head 22, and a cartridge 300 for refilling ink to the ink tank 20a.

The print head drive section 21 is controlled by a control section 40 described later when performing the drawing operation. The print head drive section 21 generates a driving electric waveform for driving the print head 22 and outputs the driving electric waveform to the print head 22. The drive electric waveform is a waveform for individually driving the drive element (piezoelectric vibrator) provided for each ejection port of the print head 22 at a timing based on the drawing command output from the control section 40.

### (Configuration of Inspection Machine)

The inspection machine 3 is a device that determines whether the drawing state of the drawing pattern drawn on the workpiece W to be drawn is good or bad on the basis of the drawing data by using a captured image acquired by imaging the workpiece W to be drawn, and corresponds to an image inspection section. Furthermore, the inspection machine 3 can also be referred to as an image inspection device. The inspection machine 3 is installed downstream of the drawing machine 2, and can inspect the drawing state of the workpiece W drawn by the drawing machine 2.

The inspection machine 3 includes an illumination section 30, an imaging section 31, a control section 32, and a storage section 33. The illumination section 30 includes, for example, a light emitting diode or the like, and is controlled by the control section 32 to emit light at a predetermined timing to illuminate a drawn portion of the workpiece W. The imaging section 31 is a member for capturing an image of a drawing pattern formed on the workpiece W and generating a captured image. The imaging section 31 includes an optical system 31a including a lens that receives light emitted from the illumination section 30 and reflected from the surface of the workpiece W, an image sensor 31b that receives light emitted from the optical system 31a, and an AF motor 31c. The AF motor 31c is a member for automatically focusing on the drawing portion of the workpiece W by driving a focusing lens of the optical system 31a. The autofocus method is not particularly limited, and examples thereof include a contrast method.

The image sensor 31b includes, for example, a complementary metal oxide semiconductor (CMOS) sensor or the like. The image sensor 31b images the workpiece W to be drawn and generates a captured image. For example, although not illustrated, the light reception amount signal of the light receiving element of the image sensor 31b is output to a field programmable gate array (FPGA) and processed, and is also output to a digital signal processor (DSP) and processed.

The control section 32 includes an imaging setting section 32a. The imaging setting section 32a is a part that sets the imaging setting parameters and reflects the set imaging setting parameters at the time of imaging the workpiece W. The imaging setting parameters include, for example, a plurality of parameters such as timing of illumination by the illumination section 30, brightness (light emission amount), exposure time by the imaging section 31, and focus (focal position) of the imaging section 31. Although not illustrated, the GUI related to the setting of the imaging setting parameters is provided with an area in which brightness of illumination, exposure time, focus, and the like can be individually set. When the user inputs each parameter on the GUI, the imaging setting section 32a accepts a setting operation by the user, outputs each parameter to, for example, the storage section 33, and causes the storage section 33 to store the parameter. Each parameter can be read from the storage section 33 as necessary.

When acquiring the captured image data of the workpiece W, the imaging setting section 32a outputs the imaging setting parameters to the illumination section 30 and the imaging section 31. The illumination section 30 and the imaging section 31 operate according to the imaging setting parameters. Upon receiving the imaging setting parameter, the illumination section 30 sets the received imaging setting parameter in the imaging section 31 so as to reflect the received imaging setting parameter at the time of imaging. Furthermore, when receiving the imaging setting parameter, the imaging section 31 also sets the received imaging setting parameter in the imaging section 31 so as to reflect the received imaging setting parameter at the time of imaging. Upon receiving the imaging trigger, the illumination section 30 and the imaging section 31 illuminate the workpiece W in accordance with the imaging setting parameters and acquire captured image data of the workpiece W by imaging.

For example, the control section 32 causes the imaging section 31 to image the workpiece W, acquires captured image data of the workpiece W, and executes an inspection based on a set inspection tool on the acquired captured image of the workpiece W. A quality determination section 32b provided in the control section 32 of the inspection machine 3 creates an inspection result by the inspection tool and compares the inspection result with the inspection condition at this time. The inspection condition is acquired from a drawing data generation section 40b of the controller 4.

### (Integral Metal Fitting)

As illustrated in FIG. 1, the inkjet print apparatus 1 includes an integral metal fitting 90 for fixing the inspection machine 3 to the drawing machine body 25 that accommodates the print head 22. The integral metal fitting 90 includes a portion to which the drawing machine body 25 is attached and a portion to which the inspection machine 3 is attached. The integral metal fitting 90 has a predetermined dimension in the conveying direction of the workpiece W, and when the inspection machine 3 is fixed to the drawing machine body 25 by the integral metal fitting 90, the inspection machine 3 and the print head 22 can be in a positional relationship of being spaced apart from each other in the conveying direction of the workpiece W, that is, a fixed positional relationship. By fixing the inspection machine 3 to the drawing machine body 25 with the integral metal fitting 90, a relative fixed positional relationship with the print head 22 is defined.

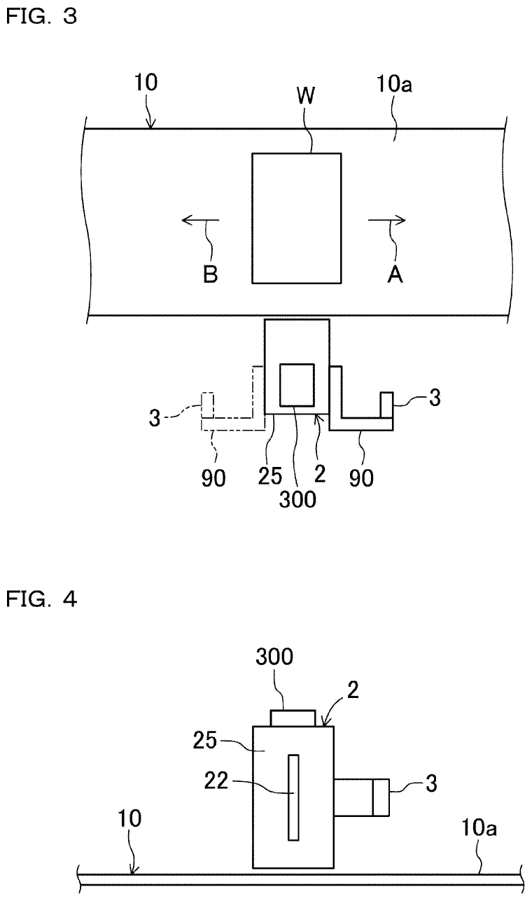

FIG. 3 is a plan view illustrating an installation example of the drawing machine 2 and the inspection machine 3. In a case where the workpiece W is conveyed in the direction of the arrow A, the inspection machine 3 can be installed on the downstream side of the drawing machine 2 in the conveying direction of the workpiece W by providing the integral metal fitting 90 as indicated by the solid line. On the other hand, in a case where the workpiece W is conveyed in the direction of the arrow B opposite to the direction of the arrow A, the inspection machine 3 can be installed on the downstream side of the drawing machine 2 in the conveying direction of the workpiece W by providing the integral metal fitting 90 as indicated by a virtual line. In addition, by simultaneously providing the integral metal fitting indicated by a solid line and the integral metal fitting 90 indicated by a virtual line, it is possible to cope with both the direction of arrow A and the direction of arrow B.

FIG. 4 illustrates an installation example of the drawing machine 2 and the inspection machine 3, and is a view (front view) as viewed from a side where ink is ejected. As illustrated in FIG. 4, the inspection machine 3 is fixed to the drawing machine body 25 by the integral metal fitting 90 such that a center of the drawing area in the up-down direction and a center of the field of view of the imaging section 31 of the inspection machine 3 in the up-down direction have the same height.

### (Detection Sensor)

As illustrated in FIG. 1, the inkjet print apparatus 1 includes the detection sensor 9 that detects arrival of the workpiece W conveyed by the conveyor 10. The detection sensor 9 is installed on the upstream side of the drawing machine 2 in the conveying direction of the workpiece W. The detection sensor 9 is provided with, for example, an optical movement measurement sensor, a distance sensor, and the like (not illustrated), and these sensors can detect arrival of the conveyed workpiece W. When detecting the arrival of the workpiece W, the detection sensor 9 transmits a detection signal to the controller 4. The controller 4 determines that the workpiece W has arrived at a predetermined position on the basis of the detection signal output from the detection sensor 9, and causes the drawing machine 2 to start drawing after a predetermined drawing delay time has elapsed.

### (Configuration of Controller 4)

As illustrated in FIG. 2, the controller 4 includes a control section 40, a storage section 41, and an operation display section 42. The control section 40 includes, for example, a microcomputer including a central processing section, various memories, and the like, and can execute software stored in advance. The control section 40 is provided with a drawing setting section 40a, the drawing data generation section 40b, an inspection setting section 40c, a display screen generation section 40d, and a mode switching section 40e. The drawing setting section 40a, the drawing data generation section 40b, the inspection setting section 40c, the display screen generation section 40d, and the mode switching section 40e of the control section 40 are parts configured by hardware and software, and are described separately for convenience as the drawing setting section 40a, the drawing data generation section 40b, the inspection setting section 40c, the display screen generation section 40d, and the mode switching section 40e, but may be integrated in hardware.

The operation display section 42 includes a controller-side display section 42a including, for example, a liquid crystal display and a controller-side operation section 42b including operation keys and the like. The controller-side operation section 42b is a part that receives various operations such as drawing contents and settings. Various screens generated by the display screen generation section 40d are displayed on the controller-side display section 42a, and the user can operate the controller-side operation section 42b while viewing the controller-side display section 42a. The operation state of the controller-side operation section 42b can be acquired by the control section 40.

The controller-side operation section 42b may be a touch panel. The touch panel is a member capable of detecting an operation by a user's finger. The type of the touch panel is not particularly limited, and examples thereof include a capacitance type and an infrared type.

Operation information of the touch panel by the user is transmitted to the control section 40.

The drawing setting section 40a is a part that sets a drawing content to be drawn on the workpiece W to be drawn. The drawing data generation section 40b is a part that defines ejection of ink in the print head 22 and generates drawing data corresponding to the drawing content set by the drawing setting section 40a. The control section 40 outputs a control signal to the print head drive section 21 on the basis of the drawing data generated by the drawing data generation section 40b, and controls ejection of ink from the ejection port of the print head 22.

The inspection setting section 40c is a part that performs inspection setting by the inspection machine 3. The storage section 41 is a part that stores a relative fixed positional relationship between the inspection machine 3 and the print head 22. The inspection setting section 40c supports the inspection setting by the user on the basis of the drawing content set by the drawing setting section 40a and the relative fixed positional relationship stored in the storage section 41.

### (Detailed Structure of Drawing Machine)

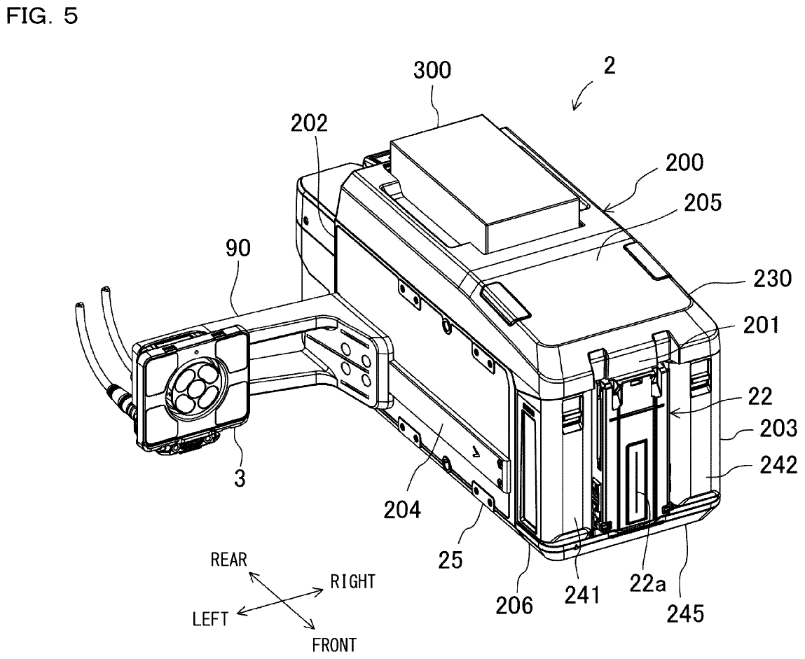

FIGS. 1 to 4 schematically illustrate the shapes of the drawing machine 2, the print head 22, the drawing machine body 25, the cartridge 300, and the like, but specific shapes of the drawing machine 2, the print head 22, the drawing machine body 25, the cartridge 300, and the like are as illustrated in each of FIG. 5 and subsequent drawings. The shapes illustrated in FIG. 5 and subsequent drawings and the shapes illustrated in FIGS. 1 to 4 may be partially different from each other, but the reason is that FIGS. 1 to 4 are drawings for conceptual description.

As illustrated in FIG. 5, the drawing machine body 25 includes a box-shaped housing 200 extending in the longitudinal direction. The ink tank 20a illustrated in FIG. 2 is provided inside the housing 200, and cannot be visually recognized from the outside. In the installation state of the drawing machine 2, the longitudinal direction of the housing 200 coincides with the width direction of the conveyor 10. In the present specification, a longitudinal direction of the housing 200 is defined as a front-rear direction, and a side facing the workpiece W at the time of installation is defined as a front side. Furthermore, a side located on the right when the drawing machine 2 is viewed from the front side is defined as the right side, a side located on the left when the drawing machine 2 is viewed from the front side is defined as the left side, and the left-right direction of the drawing machine 2 is defined as the width direction. The definition of the direction is a definition for convenience of description, and does not limit the direction according to the present invention.

As illustrated in FIG. 5, the housing 200 has a shape close to a rectangular parallelepiped that is long in the front-rear direction. Therefore, the dimension of the housing 200 in the front-rear direction is longer than the dimension of the housing 200 in the left-right direction and the dimension of the housing 200 in the up-down direction.

Since the housing 200 has a shape close to a rectangular parallelepiped, the outer peripheral surface of the housing 200 includes six surfaces. That is, the outer peripheral surface of the housing 200 includes a front surface 201 disposed to face the workpiece W, a rear surface 202 located on the opposite side of the front surface 201, a right side surface 203 located on the right when viewed from the direction facing the front surface 201, a left side surface 204 located on the left when viewed from the direction facing the front surface 201, an upper surface 205, and a lower surface 206. The front surface 201, the rear surface 202, the right side surface 203, and the left side surface 204 are surfaces constituting an outer side surface of the housing 200. One end face in the longitudinal direction of the outer side face of the housing 200 is a front face 201, and the other end face in the longitudinal direction of the outer side face of the housing 200 is a rear face 202. The front surface 201 is provided with a print head 22 for ejecting ink toward the workpiece W being conveyed. Note that the front surface 201 may be referred to as a front surface or a back surface of the rear surface 202.

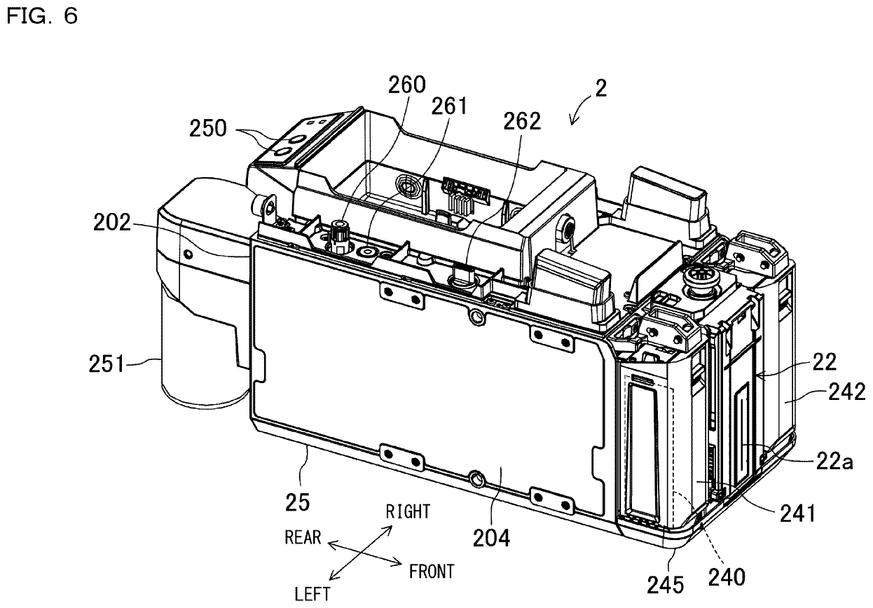

As illustrated in FIG. 5 and the like, the drawing machine 2 includes an upper cover 230 detachable from the drawing machine body 25. FIG. 6 illustrates a state in which the upper cover 230 is detached. The drawing machine 2 includes an absorber 240 (illustrated only in FIG. 6) for absorbing the ink leaking from the print head 22, and a casing 241 for accommodating the absorber 240. The absorber 240 is made of sponge, fiber, or the like.

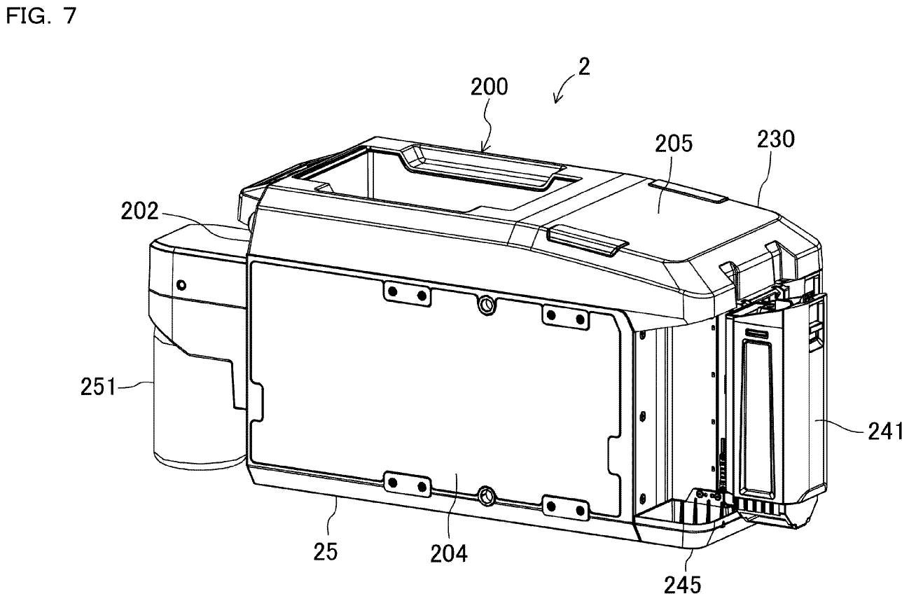

The casing 241 has a shape elongated in the up-down direction, and is detachably provided on the left side of the print head 22 on the front surface 201 of the housing 200. FIG. 7 illustrates a state in which the casing 241 is detached from the drawing machine body 25 and moved forward. As illustrated in FIG. 7, only the casing 241 can be detached from the drawing machine body 25 and replaced without removing the upper cover 230.

The absorber 240 is provided only on one of the left side and the right side of the drawing machine body 25. In this example, since the casing 241 accommodating the absorber 240 is provided on the left side of the drawing machine body 25, the absorber 240 is not provided on the right side of the drawing machine body 25. Therefore, on the right side of the drawing machine body 25, a box-shaped member 242 that does not accommodate the absorber 240 is detachably provided. The shape of the box-shaped member 242 is bilaterally symmetrical with the casing 241. Note that, in a case where the absorber 240 is provided on the left side of the drawing machine body 25, the casing 241 accommodating the absorber 240 may be detachably provided on the left side of the drawing machine body 25, and the box-shaped member 242 may be detachably provided on the right side.

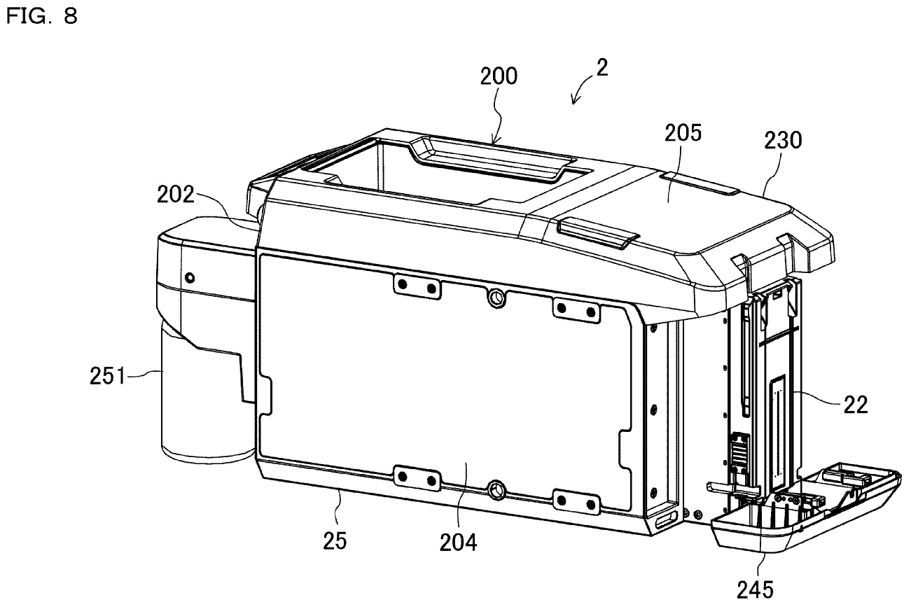

An ink reception portion 245 having a liquid feeding structure for guiding the ink leaking from the print head 22 to the absorber 240 is provided below the print head 22 in the drawing machine body 25. The ink reception portion 245 is detachably provided on a lower portion of the front surface 201 of the drawing machine body 25. FIG. 8 illustrates a state in which the casing 241, the box-shaped member 242, and the ink reception portion 245 are detached from the drawing machine body 25, and the ink reception portion 245 is moved forward.

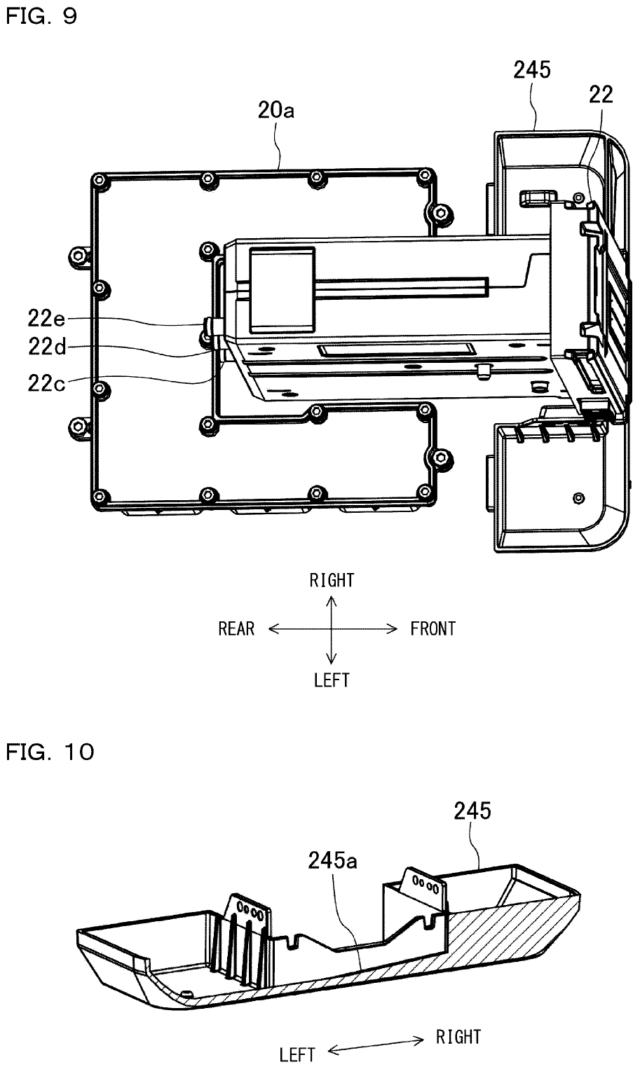

As illustrated in FIG. 9, the ink reception portion 245 is formed so as to extend to the left side and the right side below the print head 22, and has a concave shape that opens upward as a whole. The casing 241 accommodating the absorber 240 is located above the left side of the ink reception portion 245, while the box-shaped member 242 is located above the right side of the ink reception portion 245. As illustrated in FIG. 10, the bottom surface 245a of the ink reception portion 245 is inclined downward from the central portion in the left-right direction toward the left side. As a result, the ink leaking from the print head 22 can be received by the bottom surface 245a of the ink reception portion 245 and then flow to the left side, that is, the side where the absorber 240 is provided, so the ink can be reliably absorbed by the absorber 240. Note that, in a case where the absorber 240 is provided on the right side, the ink reception portion 245 having the bottom surface 245a inclined in the opposite direction may be attached.

FIG. 9 illustrates a positional relationship between the ink tank 20a and the print head 22. The ink tank 20a is installed in a lower portion of the drawing machine body 25. As illustrated in FIG. 9, the ink tank 20a is formed so as to be disposed behind the print head 22 and on the left side and the right side of the print head 22 in plan view, and is not disposed in front of the print head 22. That is, the ink tank 20a of the present embodiment is provided so as to surround a portion other than the side having the nozzle group 22a in the print head 22 in plan view.

As illustrated in FIG. 6, the drawing machine 2 includes an operation button 250. The operation button 250 is a member that receives a user instruction for controlling the drawing machine 2. The number of operation buttons 250 may be one or two or more. The operation button 250 is provided on the upper portion of the rear surface 202 of the housing 200 and is located on the side opposite to the print head 22 side. As a result, the user can operate the operation button 250 from the side opposite to the conveyor 10, and thus operability is improved. Examples of the operation button 250 include a test button to be operated in a case where test drawing is performed, a cleaning button to be operated in a case where the drawing machine 2 is cleaned, and the like, but the operation button may be a button to execute any function.

The drawing machine 2 includes a waste liquid bottle 251. A waste liquid bottle 251 is used as a collection tank that collects ink, is provided on the rear surface 202 of the housing 200, and is located on the side opposite to the print head 22 side. The waste liquid bottle 251 is a container for storing ink that has been supplied from the ink tank 20a to the print head 22 and has not been ejected toward the workpiece W. An ink inflow port (not illustrated), which is an opening of the waste liquid bottle 251, is provided in the upper portion of the waste liquid bottle 251, and is formed at a position higher than the liquid level of the ink accommodated in the ink tank 20a (illustrated in FIG. 9). The ink that has been supplied to the print head 22 and has not been ejected toward the workpiece W is fed to the opening of the waste liquid bottle 251 by the feeder, and then flows into the waste liquid bottle 251 from the opening. The waste liquid bottle 251 is configured to be detachable from the drawing machine body 25, and can discharge ink in the waste liquid bottle 251 as necessary.

Furthermore, as illustrated in a state where the upper cover 230 is detached in FIG. 6, an air filter 260 for filtering air sucked into the drawing machine body 25, a level 261, and a hand valve 262 for opening and closing an internal pipeline by manual operation are provided on the upper side of the drawing machine body 25. The air filter 260, the level 261, and the hand valve 262 are arranged in the front-rear direction. When the upper cover 230 is attached to the drawing machine body 25, the air filter 260, the level 261, and the hand valve 262 are covered by the upper cover 230 and cannot be seen from the outside.

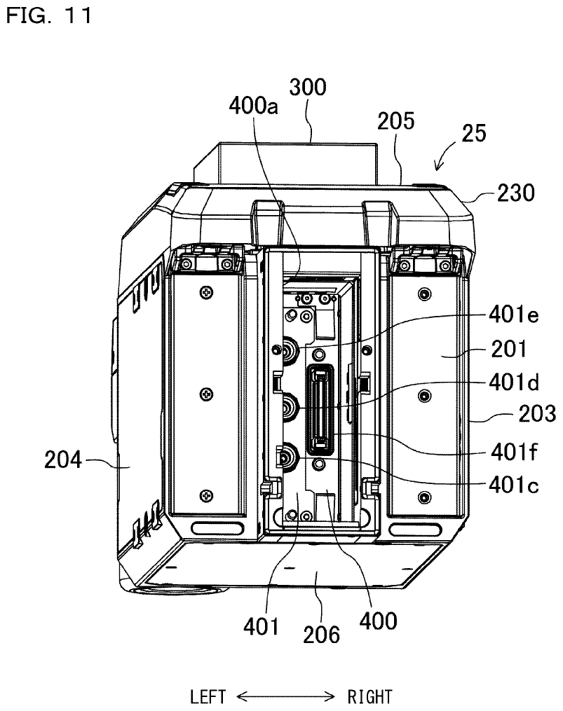

The drawing machine body 25 detachably holds the print head 22. FIG. 11 is a perspective view of the drawing machine body 25 as viewed from the front from which the print head 22, the casing 241 accommodating the absorber 240, the box-shaped member 242, and the ink reception portion 245 are detached. As illustrated in FIG. 11, a head accommodation section 400 in which the print head 22 in the mounted state is accommodated is formed in a laterally intermediate portion of the drawing machine body 25, and a front end portion of the head accommodation section 400 has an attachment port 400a for inserting and attaching the print head 22. The attachment port 400a is opened between a portion to which the casing 241 accommodating the absorber 240 is attached and a portion to which the box-shaped member 242 is attached on the front surface of the drawing machine body 25. The entire print head 22 may be accommodated in the head accommodation section 400 while the print head 22 is accommodated in the head accommodation section 400, or the front side portion of the print head 22 may be exposed to the outside of the head accommodation section 400 from the attachment port 400a.

The dimension in the up-down direction of the head accommodation section 400 is set to be longer than the dimension in the horizontal direction, and thus the head accommodation section 400 has a shape elongated in the up-down direction. The attachment port 400a also has a shape elongated in the up-down direction so as to correspond to the shape of the head accommodation section 400.

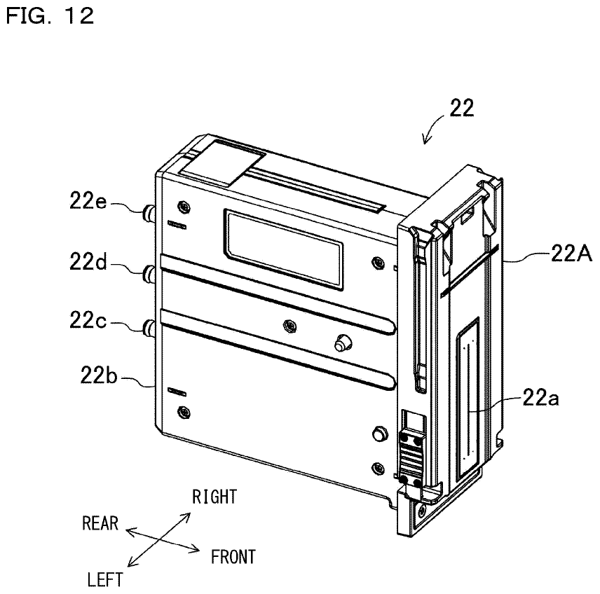

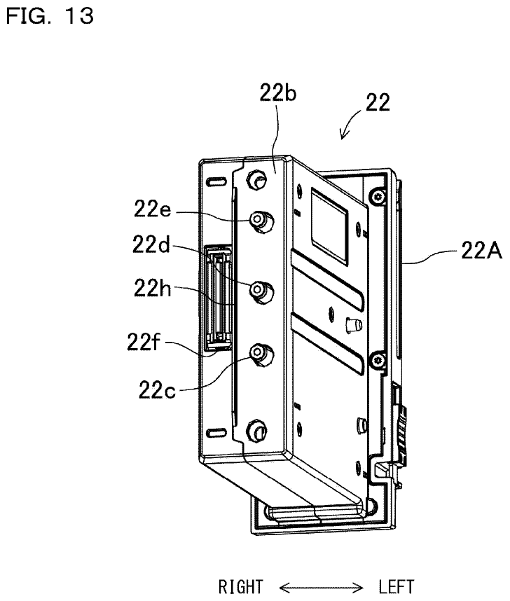

FIGS. 12 and 13 illustrate a print head 22. The print head 22 has a box shape accommodated in the head accommodation section 400. The relationship between the dimension in the up-down direction and the dimension in the horizontal direction of the print head 22 is set such that the dimension in the up-down direction is relatively long, similarly to the relationship between the dimension in the up-down direction and the dimension in the horizontal direction of the head accommodation section 400.

The print head 22 is inserted into the attachment port 400a from a rear portion thereof. On the front side opposite to the insertion direction in the print head 22, a flange portion 22A is formed so as to protrude upward, downward, rightward, and leftward. A flange portion 22A of the print head 22 is a portion disposed outside the attachment port 400a. Since the nozzle group 22a is provided on the front end surface of the print head 22, the nozzle group 22a is disposed outside the attachment port 400a of the drawing machine body 25 in a state where the print head 22 is attached to the drawing machine body 25.

The print head 22 includes a first port 22c, a second port 22d, and a third port 22e. The first port 22c, the second port 22d, and the third port 22e protrude rearward from the rear end surface 22b of the print head 22, that is, the side opposite to the side where the nozzle group 22a is provided. The first port 22c is disposed at the bottom, the third port 22e is disposed at the top, and the second port 22d is disposed between the first port 22c and the third port 22e. That is, the first port 22c, the second port 22d, and the third port 22e are arranged in one row at intervals in the up-down direction of the print head 22.

A head-side electrical connection portion 22f connected to a main-body-side electrical connection portion (described later) of the drawing machine body 25 is provided on the rear end surface 22b of the print head 22. The head-side electrical connection portion 22f includes, for example, an electrical terminal, a connector, or the like having conductivity, and protrudes toward the rear side similarly to the first port 22c, the second port 22d, and the third port 22e.

The head-side electrical connection portion 22f is disposed on the sides of the first port 22c, the second port 22d, and the third port 22e. Specifically, the first port 22c, the second port 22d, and the third port 22e are arranged in the up-down direction on the left side of the rear end surface 22b of the print head 22, while the head-side electrical connection portion 22f is disposed on the right side of the rear end surface 22b of the print head 22. As described above, by disposing the head-side electrical connection portion 22f, the first port 22c, the second port 22d, and the third port 22e separately on the left and right, even if the ink leaks from the first port 22c or the like, it becomes difficult for the ink to adhere to the head-side electrical connection portion 22f. Note that the first port 22c, the second port 22d, and the third port 22e may be disposed on the right side of the rear end surface 22b of the print head 22, and the head-side electrical connection portion 22f may be disposed on the left side of the rear end surface 22b of the print head 22.

Furthermore, although not illustrated, the head-side electrical connection portion 22f may be disposed above the first port 22c, the second port 22d, and the third port 22e. Thus, even if the ink leaks from the first port 22c or the like, the ink is less likely to adhere to the head-side electrical connection portion 22f.

The rear end surface 22b of the print head 22 is provided with a wall portion 22h between the head-side electrical connection portion 22f, and the first port 22c, the second port 22d, and the third port 22e. The wall portion 22h is a part for partitioning an area on the rear end surface 22b of the print head 22 where the head-side electrical connection portion 22f is provided and an area where the first port 22c, the second port 22d, and the third port 22e are provided. As a result, even if the ink leaks from the first port 22c or the like, the ink is prevented from flowing toward the head-side electrical connection portion 22f by the wall portion 22h. Note that the wall portion 22h may be provided as necessary.

As illustrated in FIG. 11, a lower port 401c, an intermediate port 401d, and an upper port 401e coupled to the first port 22c, the second port 22d, and the third port 22e, respectively, are provided on the back side surface 401 located at the back of the head accommodation section 400. In the present embodiment, since the first port 22c, the second port 22d, and the third port 22e are provided on the left side, the lower port 401c, the intermediate port 401d, and the upper port 401e are also provided on the left side of the back side surface 401. The first port 22c, the second port 22d, and the third port 22e are connected to the lower port 401c, the intermediate port 401d, and the upper port 401e by inserting one into the other.

A body-side electrical connection portion 401f is provided on the back side surface 401 of the head accommodation section 400. In the present embodiment, since the head-side electrical connection portion 22f is provided on the right side, the body-side electrical connection portion 401f is also provided on the right side of the back side surface 401. Similarly to the head-side electrical connection portion 22f, the body-side electrical connection portion 401f includes, for example, an electrical terminal, a connector, or the like having conductivity. For example, one of the body-side electrical connection portion 401f and the head-side electrical connection portion 22f may be configured by a male connector, and the other may be configured by a female connector.

### (Flow Path Structure of Ink and Air)

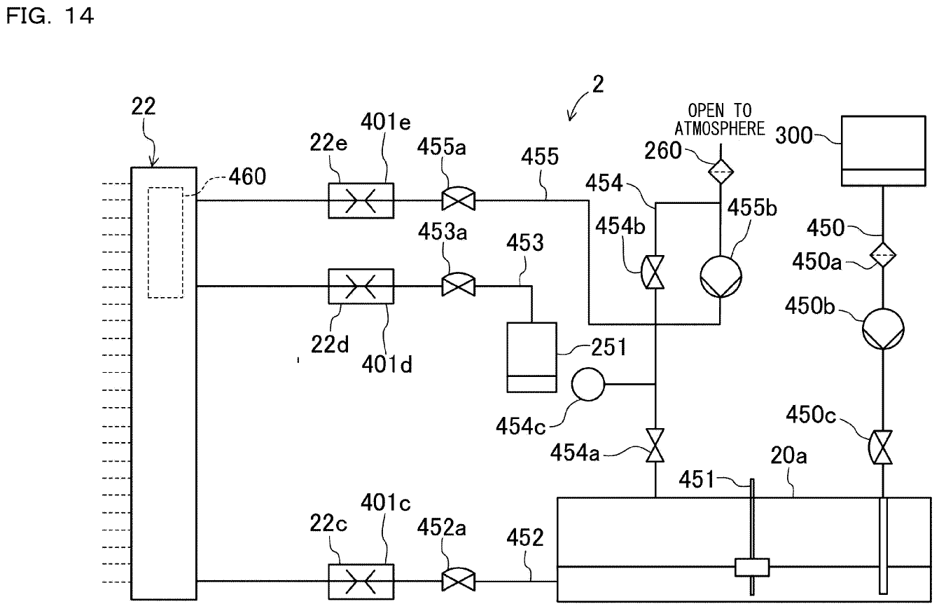

FIG. 14 is a schematic diagram illustrating a flow path structure of the drawing machine 2. The drawing machine 2 includes a cartridge flow path 450 including a piping member that connects the cartridge 300 and the ink tank 20a. The ink accommodated in the cartridge 300 is supplied to the ink tank 20a via the cartridge flow path 450. The cartridge flow path 450 is provided with an ink filter 450a that filters ink, an ink pump 450b that feeds ink, and a cartridge valve 450c that opens and closes the cartridge flow path 450 in order from the upstream side to the downstream side. The cartridge valve 450c is an electromagnetic valve. The ink pump 450b and the cartridge valve 450c are controlled by, for example, the controller 4 or the like.

The ink tank 20a is provided with a level meter 451 that measures the amount of ink in the ink tank 20a. A measurement result by the level meter 451 is output to the controller 4. The controller 4 controls the ink pump 450b and the cartridge valve 450c to supply the ink in the cartridge 300 to the ink tank 20a so that the amount of ink in the ink tank 20a falls within a predetermined range.

The drawing machine 2 includes a supply path 452 constituted by a piping member extending from the ink tank 20a to the lower port 401c. The supply path 452 is for supplying the ink accommodated in the ink tank 20a to the print head 22. A supply valve 452a including an electromagnetic valve that opens and closes the supply path 452 is provided in the middle of the supply path 452. The supply valve 452a is controlled by the controller 4 or the air supply control section 27. A lower port 401c is connected to the downstream side of the supply path 452. Since the lower port 401c is connected to the first port 22c of the print head 22, the first port 22c is a port that receives supply of ink from the ink tank 20a. The print head 22 ejects the ink from the first port 22c toward the workpiece W being conveyed.

The drawing machine 2 includes a discharge flow path 453 constituted by a pipe member extending from the intermediate port 401d to the waste liquid bottle 251. The discharge flow path 453 is a flow path that discharges ink in the pressure fluctuation adjustment section 460 (described later) to the waste liquid bottle 251 via the second port 22d and the intermediate port 401d. The inner diameter of the discharge flow path 453 is set to a certain size or more so that the ink does not stay due to surface tension.

Furthermore, the discharge flow path 453 is provided so as to suppress undulation against the direction of gravity. Specifically, the upstream side of the discharge flow path 453 is a side connected to the intermediate port 401d, and the downstream side of the discharge flow path 453 is a side connected to the waste liquid bottle 251. The shape of the discharge flow path 453 is set such that the upstream side of the discharge flow path 453 is positioned on the downstream side of the discharge flow path 453 and above the intermediate portion in the flow direction, and the downstream side of the discharge flow path 453 is positioned on the upstream side of the discharge flow path 453 and below the intermediate portion in the flow direction. With such a shape, the ink can naturally flow down by gravity from the upstream side to the downstream side of the discharge flow path 453. That is, the discharge flow path 453 is provided so that the ink can flow down naturally.

A discharge valve 453a including an electromagnetic valve that opens and closes the discharge flow path 453 is provided in the middle of the discharge flow path 453. The discharge valve 453a is controlled by the controller 4 and the air supply control section 27. Since the intermediate port 401d is connected to the second port 22d of the print head 22, the second port 22d is a port that ejects ink that has not been ejected from the print head 22 to the waste liquid bottle 251.

The drawing machine 2 includes a first flow path 454 connected to an upper portion (a portion where air is present) of the ink tank 20a and a second flow path 455 connected to the third port 22e. The first flow path 454 extends from the upper portion of the ink tank 20a to the air filter 260, and can be opened to the atmosphere via the air filter 260. A tank-side electromagnetic valve 454a that opens and closes the first flow path 20 is provided on the ink tank 454a side of the first flow path 454. On the air filter 260 side of the first flow path 454, a filter-side electromagnetic valve 454b that opens and closes the first flow path 454 is provided. The tank-side electromagnetic valve 454a and the filter-side electromagnetic valve 454b are controlled by the controller 4 and the air supply control section 27.

A pressure gauge 454c that measures the pressure in the first flow path 454 is provided between the tank-side electromagnetic valve 454a and the filter-side electromagnetic valve 454b of the first flow path 454. The measurement result by the pressure gauge 454c is output to the controller 4 and the air supply control section 27.

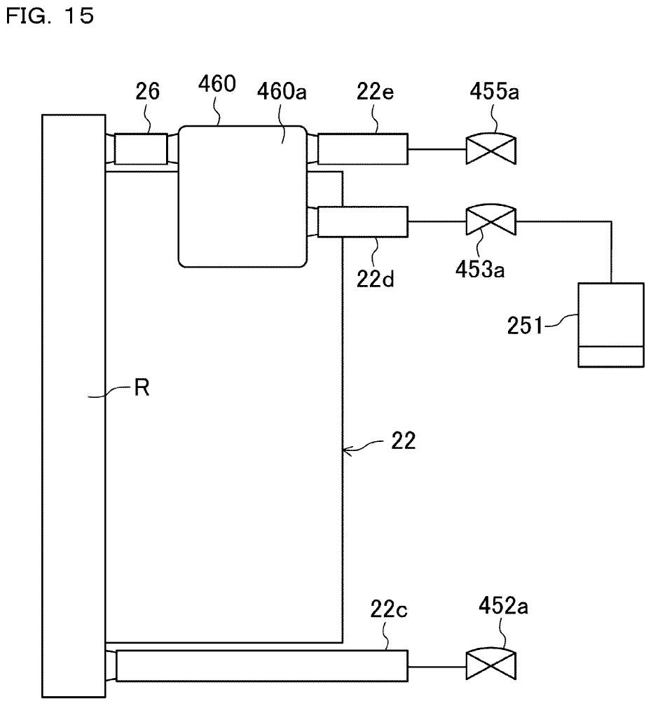

The second flow path 455 extends from the third port 22e to the air filter 260, and can be opened to the atmosphere via the air filter 260. An air flow path opening/closing valve 455a including an electromagnetic valve that opens and closes the second flow path 455 is provided on the third port 22e side of the second flow path 455. Although the second flow path 455 is a flow path through which air flows, since the second flow path is connected to the pressure fluctuation adjustment section 460 via the upper port 401e and the third port 22e, there is a possibility that the ink in the damper chamber 460a (illustrated in FIG. 15 and the like) of the pressure fluctuation adjustment section 460 flows into the second flow path 455. In the present embodiment, a portion of the second flow path 455 closer to the third port 22e than the air flow path opening/closing valve 455a is inclined downward so as to be positioned lower toward the third port 22e. As a result, even if the ink in the damper chamber 460a flows into the second flow path 455, the flown ink can be returned into the damper chamber 460a by its own weight.

An air pump 455b that supplies air to the third port 22e side is provided on the air filter 260 side of the second flow path 455. The air pump 455b is for pumping air to the pressure fluctuation adjustment section 460 via the third port 22e. The air flow path opening/closing valve 455a and the air pump 455b are controlled by the controller 4 and the air supply control section 27. Furthermore, a portion of the second flow path 455 between the air flow path opening/closing valve 455a and the air pump 455b is connected between the tank-side electromagnetic valve 454a and the filter-side electromagnetic valve 454b of the first flow path 454.

Furthermore, the air pump 455b can also pump air into the ink tank 20a through the first flow path 454. That is, when the air pump 455b is rotated in a state where the filter-side electromagnetic valve 454b and the air flow path opening/closing valve 455a are closed and the tank-side electromagnetic valve 454a is opened, air can be pumped into the ink tank 20a to pressurize the ink tank 20a. Thus, pumping air to the pressure fluctuation adjustment section 460 and pressurizing the ink tank 20a can be executed by the single air pump 455b. Note that, although not illustrated, an air pump that pumps air to the pressure fluctuation adjustment section 460 and an air pump that pressurizes the ink tank 20a may be provided.

As illustrated in FIG. 15, the print head 22 includes an ink storage chamber R in which ink before being ejected from the nozzle group 22a is stored, and a pressure fluctuation adjustment section 460 that suppresses pressure fluctuation of ink in the ink storage chamber R. A first port 22c is connected to a lower side of the ink storage chamber R, and ink is supplied to the ink storage chamber R through the first port 22c.

The upper side of the ink storage chamber R is an outlet side from which the ink that has not been ejected from the nozzle group 22a flows out. A pressure fluctuation adjustment section 460 is connected to the outlet side of the ink storage chamber R via a pipe 26. The ink storage chamber R constitutes a part of an ink flow path between the first port 22c and the second port 22d. The pressure fluctuation adjustment section 460 is disposed in the middle of the ink flow path between the first port 22c and the second port 22d. More specifically, the pressure fluctuation adjustment section 460 is interposed between the ink storage chamber R and the second port 22d. Note that the pressure fluctuation adjustment section 460 may be connected to the ink inflow side that is the lower side of the ink storage chamber R. However, it is advantageous in that mixing of air into the ink storage chamber R can be suppressed by connecting the pressure fluctuation adjustment section 460 to the ink outlet side of the ink storage chamber R.

The pressure fluctuation adjustment section 460 is a so-called air damper, and a damper chamber 460a is formed therein. The ink in the ink tank 20a flows into the ink storage chamber R via the supply valve 452a and the first port 22c, and among the ink, ink that has not been ejected from the nozzle group 22a flows into the damper chamber 460a and is stored therein.

The second port 22d is a port that is connected to a lower portion of the damper chamber 460a and discharges ink stored in the damper chamber 460a. Therefore, the discharge valve 453a is a second electromagnetic valve that is disposed in the middle of the discharge flow path 453 for discharging the ink in the pressure fluctuation adjustment section 640 to the waste liquid bottle 251 via the second port 22d and opens and closes the discharge flow path 453.

The third port 22e is provided at a position separated upward from the second port 22d, and is connected to an upper portion of the damper chamber 460a. The third port 22e is a port for receiving air supply to the damper chamber 460a of the pressure fluctuation adjustment section 460. Therefore, the air flow path opening/closing valve 455a is a first electromagnetic valve disposed in the middle of the air flow path for supplying air to the pressure fluctuation adjustment section 460 via the third port 22e.

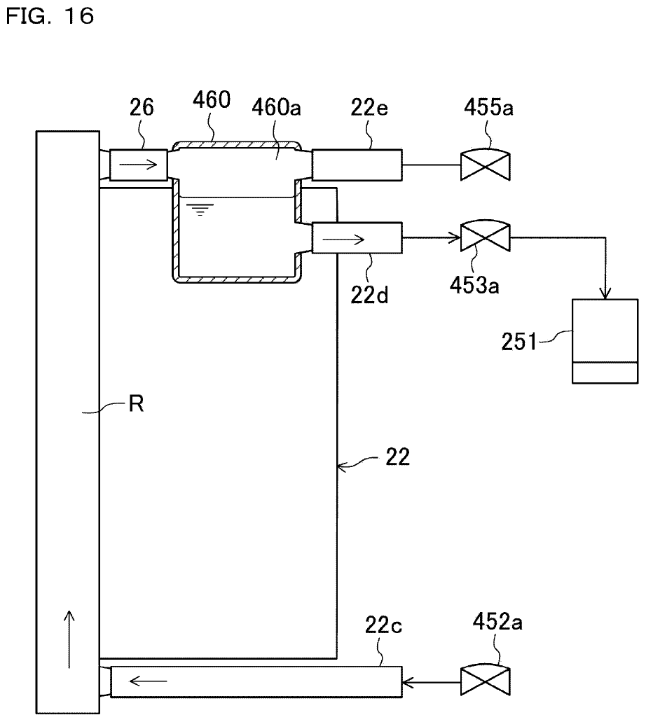

As illustrated in FIG. 16, during the operation of the drawing machine 2, the ink and air flowing from the ink tank 20a are accommodated in the damper chamber 460a of the pressure fluctuation adjustment section 460. The damper chamber 460a is not provided with a damper sheet, and the liquid level of the ink accommodated in the damper chamber 460a is in contact with air. That is, the pressure fluctuation adjustment section 460 is an air damper in which no damper sheet is provided.

As indicated by a plurality of arrows in FIG. 16, during the drawing, the ink in the ink tank 20a flows into the ink storage chamber R through the supply valve 452a and the first port 22c, and is ejected from the nozzle group 22a. The ink that has not been ejected from the nozzle group 22a flows into and is stored in the damper chamber 460a of the pressure fluctuation adjustment section 460. Since air is also present in the damper chamber 460a, for example, in a case where the print head 22 vibrates, the air in the damper chamber 460a expands and contracts, whereby the pressure fluctuation of the ink in the ink storage chamber R is suppressed. As a result, fluctuations in the ink ejection pressure from the nozzle group 22a can be absorbed, and the drawing accuracy is improved. In other words, since the fluctuation of the pressure applied to the meniscus formed in the nozzle group 22a can be suppressed, the non-ejection due to the missing nozzle is prevented, and as a result, the drawing accuracy is improved. In particular, since the pressure fluctuation adjustment section 460 does not have the damper sheet, the response speed to the pressure fluctuation of the ink in the ink storage chamber R is extremely fast, and the drawing accuracy can be further enhanced.

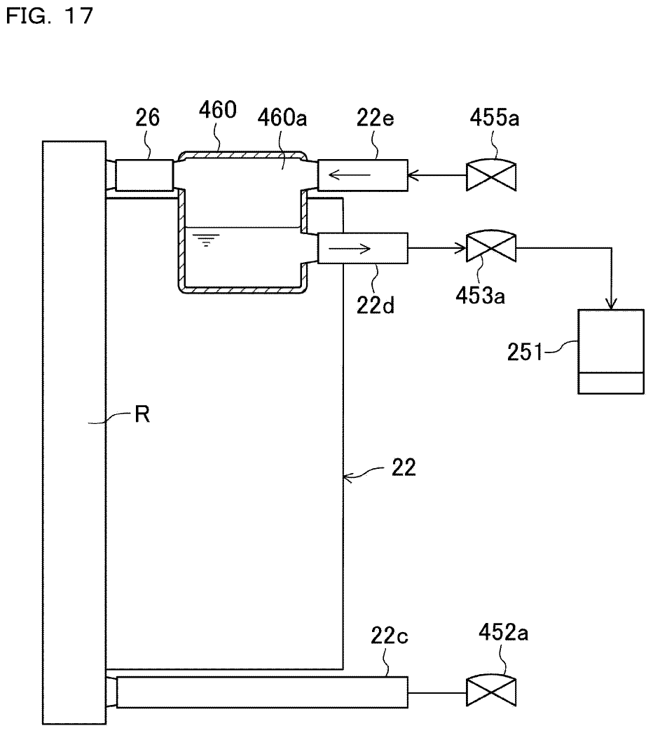

Since the pressure fluctuation adjustment section 460 does not have the damper sheet, for example, the liquid level of the ink in the ink storage chamber R may become high during the drawing. The reason why the liquid level in the ink storage chamber R becomes high is that the air in the damper chamber 460a directly contacts the ink liquid level, so that the air may be dissolved in the ink, or the air may be mixed in the ink as air bubbles at the time of vibration impact or the like, and the air may be discharged from the damper chamber 460a through the second port 22d. When the liquid level of the ink in the ink storage chamber R increases, the amount of air in the ink storage chamber R decreases accordingly, so that the effect of suppressing the pressure fluctuation may decrease. On the other hand, as illustrated in FIG. 17, the drawing machine 2 according to the present embodiment includes an air supply control section 27 (illustrated in FIG. 2) that performs refresh control of performing control to open the air flow path opening/closing valve 455a and the discharge valve 453a and supplying air into the ink storage chamber R at the time of non-ejection of ink by the print head 22 (at the time of non-drawing), and a timing storage section 28 that stores the timing of performing the refresh control. The timing storage section 28 automatically stores the date and time when the refresh control was performed last time. Furthermore, the timing storage section 28 also stores information related to the frequency of refresh control. For example, in a case where it is desired to perform the refresh control again at a timing when a certain period of time has elapsed since the previous refresh control was performed, the “certain period of time” is stored in the timing storage section 28 and used in the flow to be described later.

The air supply control section 27 and the timing storage section 28 may be provided in the drawing machine body 25, or may be provided outside the drawing machine body 25 separately from the drawing machine body 25. For example, the controller 4 may include the air supply control section 27 and the timing storage section 28. In this case, the air supply control section 27 and the timing storage section 28 of the controller 4 cause the drawing machine body 25 to perform refresh control.

The example illustrated in FIG. 17 illustrates self-weight refreshing in which air is supplied into the ink storage chamber R using the self-weight of the ink. Since the discharge flow path 453 is provided so as to suppress undulation against the direction of gravity and has an inner diameter larger than or equal to a certain value so that the ink does not stay due to surface tension, the self-refreshing is possible. Note that, in the case of refreshing using an air pump 455b to be described later, the discharge flow path 453 may have undulation against the direction of gravity, or may have an inner diameter less than a certain value.

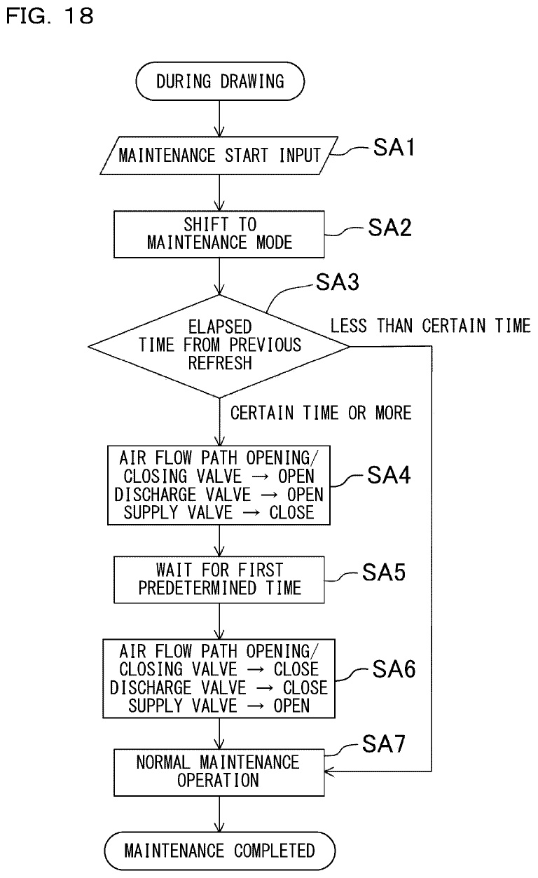

Details of the self-weight refreshing will be described with reference to a flowchart illustrated in FIG. 18. In step SA1, a maintenance start input is made by the user. In step SA2, when the air supply control section 27 detects that the maintenance start input has been made, the drawing machine 2 during drawing is shifted to the maintenance mode. The maintenance mode is when the ink is not ejected from the print head 22, that is, when the ink is not ejected by the print head 22.

In step SA3, the air supply control section 27 acquires the previous refresh date and time and the current date and time stored in the timing storage section 28. The air supply control section 27 determines, on the basis of the acquired previous refresh date and time and the current time, whether a certain time (period) or more has elapsed since the previous refresh date and time. If a certain time has not elapsed from the previous refresh date and time, the process proceeds to step SA7, and the drawing machine 2 performs the normal maintenance operation without performing the refresh control. Note that the previous refresh date and time may be affected by other maintenance. Specifically, in a case where the print head 22 fails or in a case where the ink stored in the ink storage chamber 460 is replaced, the air supply control section 27 performs the refresh control regardless of the previous refresh date and time, and the previous refresh date and time stored in the timing storage section 28 is also updated.

In a case where the certain period of time has elapsed from the previous refresh date and time, the process proceeds to step SA4. In step SA4, the air supply control section 27 opens the air flow path opening/closing valve 455a and the discharge valve 453a, and closes the supply valve 452a. Since the damper chamber 460a is opened to the atmosphere by opening the air flow path opening/closing valve 455a, air can flow into the damper chamber 460a. Furthermore, when the discharge valve 453a is opened, the damper chamber 460a communicates with the inside of the waste liquid bottle 251. In this state, the process proceeds to step SA5, and waits for a first predetermined time. The first predetermined time is not particularly limited, but may be, for example, about several seconds to 10 seconds. While waiting, the ink in the damper chamber 460a flows through the discharge flow path 453 through the second port 22d by its own weight and flows into the waste liquid bottle 251. At the same time, air flows into the damper chamber 460a from the third port 22e, and the height of the liquid level of the ink in the ink storage chamber R falls within an appropriate range. Specifically, air flows into the damper chamber 460a from the third port 22e so that the damper chamber 460a becomes empty once, and thereafter, by performing purge control at an appropriate pressure, an appropriate amount of ink flows into the damper chamber 460a from the ink storage chamber R. As described above, the air supply control section 27 performs the refresh control again in a case where a certain period of time has elapsed from the timing at which the refresh control stored in the timing storage section 28 is performed.

In step SA6, the air supply control section 27 closes the air flow path opening/closing valve 455a and the discharge valve 453a, and opens the supply valve 452a. Furthermore, the date and time when the refresh control has been performed is stored in the timing storage section 28. Thereafter, in step SA7, the drawing machine body 25 executes the normal maintenance operation.

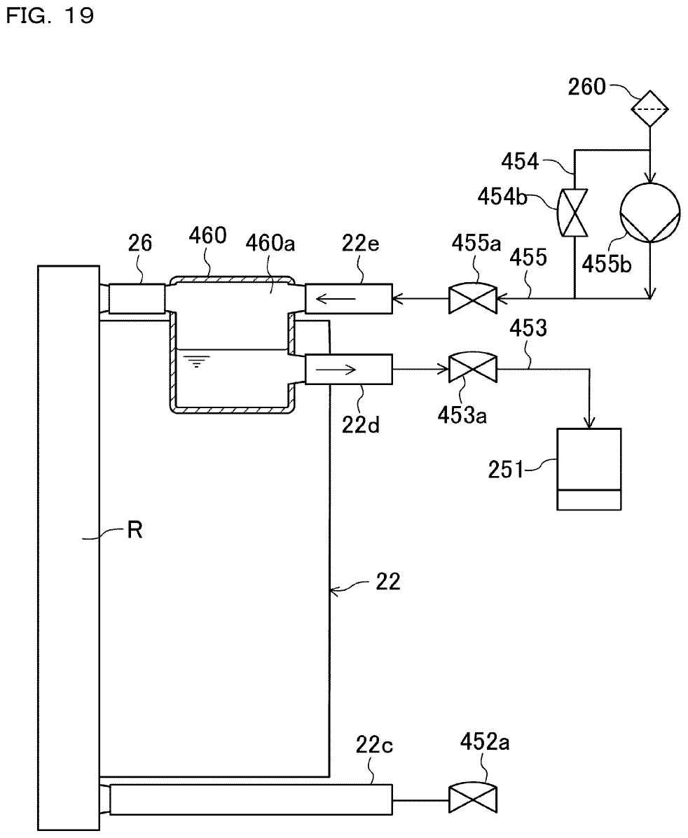

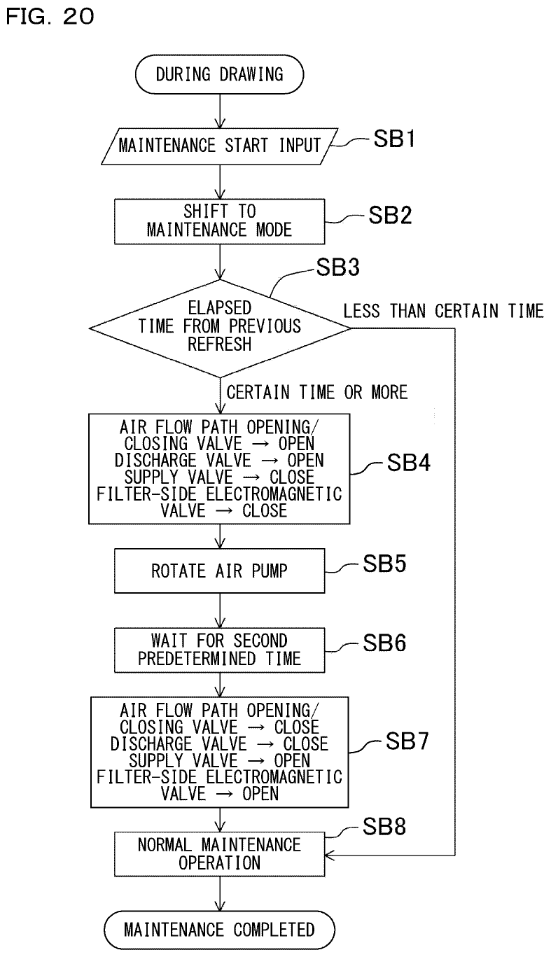

In the present embodiment, pump refreshing using the air pump 455b can be performed in addition to the self weight refreshing. FIG. 19 illustrates the flow of air and ink in a case where pump refreshing is performed. Details of pump refreshing will be described with reference to a flowchart illustrated in FIG. 20. In step SB1, a maintenance start input is made by the user. In step SB2, when the air supply control section 27 detects that the maintenance start input has been made, the drawing machine 2 being drawn is shifted to the maintenance mode.

In step SB3, the air supply control section 27 acquires the previous refresh date and time and the current date and time stored in the timing storage section 28. The air supply control section 27 determines, on the basis of the acquired previous refresh date and time and the current time, whether a certain time (period) or more has elapsed since the previous refresh date and time. If a certain time has not elapsed since the previous refresh date and time, the process proceeds to step SB8, and the drawing machine 2 performs the normal maintenance operation without performing the refresh control.

In a case where the certain period of time has elapsed from the previous refresh date and time, the process proceeds to step SB4. In step SB4, the air supply control section 27 opens the air flow path opening/closing valve 455a and the discharge valve 453a, and closes the supply valve 452a and the filter-side electromagnetic valve 454b. Thereafter, the process proceeds to step SB5, where the air supply control section 27 rotates the air pump 455b. As a result, air is pumped from the third port 22e to the damper chamber 460a.

In this state, the process proceeds to step SB6 and waits for a second predetermined time. The second predetermined time is set to be shorter than the first predetermined time, and can be, for example, a short time of about 1 second. While waiting, the ink in the damper chamber 460a flows through the discharge flow path 453 through the second port 22d and flows into the waste liquid bottle 251 by the pressure of the air pumped by the air pump 455b. As a result, the height of the liquid level of the ink in the ink storage chamber R falls within an appropriate range. As described above, the air supply control section 27 performs the refresh control again in a case where a certain period of time has elapsed from the timing at which the refresh control stored in the timing storage section 28 is performed.

In step SB7, the air supply control section 27 closes the air flow path opening/closing valve 455a and the discharge valve 453a, and opens the supply valve 452a and the filter-side electromagnetic valve 454b. Furthermore, the date and time when the refresh control has been performed is stored in the timing storage section 28. Thereafter, in step SB8, the drawing machine body 25 executes the normal maintenance operation.

As illustrated in FIGS. 18 and 19, by incorporating the refresh control into the normal maintenance operation, the user does not need to separately perform an operation for performing the refresh control. Note that the user may perform an operation for performing the refresh control, and the air supply control section 27 may receive the operation to perform the refresh control. Moreover, the display screen generation section 40d may create a notification screen prompting a user operation for performing refresh control, and display the notification screen on the terminal-side display section 5a. That is, the display screen generation section 40d and the terminal-side display section 5a function as a notification section that performs notification for prompting a user operation for opening the air flow path opening/closing valve 455a and supplying air into the pressure fluctuation adjustment section 460. Furthermore, the timing to perform the refresh control may be determined on the basis of the number of times of drawing, the amount of consumed ink, and the like after the previous refresh control is performed. For example, the air supply control section 27 can determine whether or not the number of times of drawing has exceeded a predetermined number of times since the previous refresh control was performed, and perform the refresh control in a case where the number of times of drawing has exceeded the predetermined number of times, or can determine whether or not the amount of ink consumed has exceeded a predetermined amount since the previous refresh control was performed, and perform the refresh control in a case where the amount of ink consumed has exceeded the predetermined amount.

Furthermore, the air supply control section 27 can also detect ON/OFF of a power supply of the drawing machine 2 and perform refresh control when the power supply is ON or OFF.

Furthermore, the air flow path opening/closing valve 455a for supplying air to the pressure fluctuation adjustment section 460 may not be an electromagnetic valve but may be a manual valve. In this case, the user manually opens the air flow path opening/closing valve 455a instead of the air supply control section 27 performing the control to open the air flow path opening/closing valve 455a. When it is determined in step SA3 of FIG. 18 that the elapsed time from the previous refresh is longer than or equal to the certain time, the display screen generation section 40d creates a notification screen prompting the user to perform a manual operation for opening the air flow path opening/closing valve 455a, and the notification screen is displayed on the terminal-side display section 5a. That is, the display screen generation section 40d and the terminal-side display section 5a function as a notification section that performs notification for prompting a user operation for opening the air flow path opening/closing valve 455a and supplying air into the pressure fluctuation adjustment section 460. By displaying the notification screen, it is possible to grasp that the time has elapsed from the previous refresh and it is necessary to refresh by operating the manual valve. The notification screen may be, for example, an error screen for notifying that the effect of suppressing the pressure fluctuation by the pressure fluctuation adjustment section 460 has decreased.

The above-described embodiments are merely examples in all respects, and should not be construed in a limiting manner. Moreover, all modifications and changes falling within the equivalent scope of the claims are within the scope of the present invention.

As described above, the drawing machine according to the present invention can be used, for example, when information is drawn on an object to be drawn conveyed by a conveyor.

What is claimed is:

1. A drawing machine that ejects ink for drawing information on an object to be drawn conveyed by a conveyor, the drawing machine comprising:
an ink tank configured to accommodate ink;
a collection tank configured to collect ink;
a print head including a first port that receives supply of ink from the ink tank, a second port that discharges ink to the collection tank, a pressure fluctuation adjustment section disposed in a middle of an ink flow path between the first port and the second port, and a third port that receives air supply to the pressure fluctuation adjustment section, and configured to eject ink from the first port toward the object to be drawn that is being conveyed;
a first electromagnetic valve disposed in a middle of an air flow path that supplies air to the pressure fluctuation adjustment section via the third port, and configured to open and close the air flow path; and
an air supply control section configured to open the first electromagnetic valve and supply air into the pressure fluctuation adjustment section.

2. The drawing machine according to claim 1, wherein
the air supply control section opens the first electromagnetic valve to supply air into the pressure fluctuation adjustment section when the print head does not eject ink.

3. The drawing machine according to claim 1, further comprising
a second electromagnetic valve disposed in a middle of a discharge flow path that discharges ink in the pressure fluctuation adjustment section to the collection tank via the second port and configured to open and close the discharge flow path,
wherein the air supply control section performs control to open the first electromagnetic valve and the second electromagnetic valve when the print head does not eject ink.

4. The drawing machine according to claim 1, further comprising
a pump configured to pump air to the pressure fluctuation adjustment section via the third port.

5. The drawing machine according to claim 1, further comprising
a timing storage section configured to store a timing at which refresh control of opening the first electromagnetic valve and supplying air into the pressure fluctuation adjustment section is performed,
wherein the air supply control section performs the refresh control again in a case where a certain period of time has elapsed from a timing at which the refresh control is performed stored in the timing storage section.

6. The drawing machine according to claim 1, wherein
a discharge flow path that discharges ink in the pressure fluctuation adjustment section to the collection tank via the second port is provided not to have undulation against a gravity direction.

7. The drawing machine according to claim 1, wherein
an ink storage chamber that stores ink ejected from a nozzle is formed in a middle of the ink flow path between the first port and the second port in the print head, and
the pressure fluctuation adjustment section is interposed between the ink storage chamber and the second port.

8. The drawing machine according to claim 1, wherein
the pressure fluctuation adjustment section accommodates ink flowing in from the ink tank and air, and a liquid level of the accommodated ink and the air are in contact with each other.

9. The drawing machine according to claim 2, wherein
when the print head does not eject ink, a maintenance mode is set.

10. A drawing machine that ejects ink for drawing information on an object to be drawn conveyed by a conveyor, the drawing machine comprising:
an ink tank configured to accommodate ink;
a collection tank configured to collect ink;
a print head including a first port that receives supply of ink from the ink tank, a second port that discharges ink to the collection tank, a pressure fluctuation adjustment section disposed in a middle of an ink flow path between the first port and the second port, and a third port that receives air supply to the pressure fluctuation adjustment section, and configured to eject ink from the first port toward the object to be drawn that is being conveyed;
a first valve disposed in a middle of an air flow path that supplies air to the pressure fluctuation adjustment section via the third port, and configured to open and close the air flow path; and
a notification section configured to perform a notification related to a user operation for opening the first valve and supplying air into the pressure fluctuation adjustment section.
